(19) United States
(12) Patent Application Publication
(10) Pub. No.: US 2024/0042731 A1
(43) Pub. Date: Feb. 8, 2024

(54) THERMALLY INSULATING SUBSTRATE PRODUCT AND METHOD OF MANUFACTURE

(71) Applicant: TEXAVIE TECHNOLOGIES INC., Vancouver, BC (CA)

(72) Inventors: Peyman SERVATI, Vancouver (CA); Rou Yi YEAP, Vancouver (CA); Fatemeh ZABIHI, Vancouver (CA); Harishkumar NARAYANA, Vancouver (CA); Amir SERVATI, Vancouver (CA); Saeid SOLTANIAN, Vancouver (CA); Katherine Hoang Kieu-Linh LE, Vancouver (CA); Hamdi Harun ARKAZ, Vancouver (CA); Zenan JIANG, Vancouver (CA)

(21) Appl. No.: 18/266,552

(22) PCT Filed: Dec. 17, 2021
(86) PCT No.: PCT/CA2021/051834

§ 371 Date: Jun. 9, 2023

Related U.S. Application Data
(60) Provisional application No. 63/199,326, filed on Dec. 18, 2020.

(51) Int. Cl. B32B 5/30; B32B 5/02; B32B 5/26; B32B 5/24

(52) U.S. Cl. CPC B32B 5/30; B32B 5/024; B32B 5/271; B32B 5/245; B32B 2264/105; B32B 2307/304; B32B 2307/72; B32B 2307/726; B32B 2307/724; B32B 2307/20; B32B 2307/4026; B32B 2305/026; B32B 2305/188

(57) ABSTRACT

This invention relates to a thermally insulating substrate product comprising: a substrate having at least one layer and comprising metallic particles having an average particle size and density selected to block or reflect infrared radiation and aerogel particles having an average pore size and density selected to control conducted and convected thermal energy. The thermally insulating substrate can made as textile and/or film coatings that are light and thin and adapts to external environment conditions for better camouflage as well as improved heat insulation for energy conservation and thermal regulation.

### FIELD OF DISCLOSURE

This disclosure relates generally a thermally insulating substrate product, and a method of manufacturing same.

### BACKGROUND

Infra-red (IR) spectrum of light carries a large amount of thermal energy and can be emitted from any surface or body. This IR radiation is generated from the atomic and inter-atomic vibrations and can have photon wavelengths in the range of 0.78 to 1,000 micrometers. This emission can be categorized into near-IR (0.78 to 2.5 micrometers), mid-IR (2.5 to 25 micrometers) and far-IR (25 to 1,000 micrometers). This emission leads to heat loss or absorption and transfer of energy in addition to other heat transfer methods such as convection and conduction, and also can be detected by IR cameras and detectors in night vision and night or day surveillance. To improve insulation, comfort and efficiency in a cold environment, it is desirable to suppress this emission to improve comfort and increase energy conservation. This is critical for saving energy for insulation of houses, vehicles, jackets, tents, and sleeping bags that should function for conserving heat in a cold climate. In a hot climate, reflecting the IR radiation coming from sun helps a house, a car or wearer of clothing to stay cooler. As a result, controlled reflection and blocking of IR radiation can be used for both staying hot or cool in different external environments.

In addition, because of the advances in IR cameras and detectors, it is critical to reduce the IR emission over different spectral ranges (near-IR, mid-IR, and far-IR) from bodies of military and security personnel and vehicles for concealing them from external detection and threats. It is therefore desirable that the IR radiation from the body is reduced and matched with that of the surrounding environment to achieve an adaptive camouflage that helps in concealing the personnel and vehicles from IR detectors, cameras and threat in different external environments. For this purpose, it is not only to reduce the IR emission but also match it to that of the surrounding environment. The IR concealing can also be important in view of privacy concerns caused by the widespread use of IR cameras for monitoring people. Therefore, broad-band IR-shielding materials and technologies are essential for adaptive camouflage and concealing of military personnel, equipment, vehicles, and accessories in different environments as well as providing heat and energy conservation, insulation and comfort for military and emergency personnel as well as general consumers.

Some patents that describe the current state of the art for systems for camouflage, concealing and insulating fabric and textile structures include:
U.S. Pat. No. 7,832,018 presents a camouflage suit by using electrically conductive fabric;
U.S. Pat. No. 8,916,265 presents a multi-spectral, selectively reflective construct to reduce IR emission; and
U.S. Pat. No. 8,918,919 presents an infra-red reflecting covering material.

### SUMMARY

Aspects of the invention relate to a thermally insulating substrate product that provides multiple functions including high and controllable thermal insulation, adaptive matching of thermal properties of the fabric with surrounding environment and reducing IR emission from the covered body to achieve energy conservation and adaptive camouflage. Thermal insulation and thermal regulation are provided by nanoporous aerogel particles and phase change material that control thermal conduction, convection, and IR emission in addition to storing heat energy to adapt to the external environmental temperature. The thermally insulating substrate product also includes IR blocking particles that significantly conceal and disperse IR emission. The combination can provide adaptive IR blocking and thermal insulation in a thin, light and flexible form that can be added to existing fabric as coating without adversely impacting the use and function of existing fabrics. In addition, the thermally insulating substrate product can include thicker foams and layers, thus providing insulation as well as spongy cushion and mechanical support for puffy jackets, shoes, or insulation in vehicles and houses. The thermally insulating substrate product can comprise a textile substrate formed from a variety of diameters of yarns and threads and be integrated in a woven, knitted, braided or unwoven fabric structures for delivery of controllable degree of adaptive IR concealing and thermal insulating and regulating functionality in a variety of apparel forms.

According to one aspect of the invention, there is provided a thermally insulating substrate product comprising: a substrate having at least one layer and comprising metallic particles having an average particle size and density selected to block or reflect infrared radiation and aerogel particles having an average pore size and density selected to control conducted and convected thermal energy. In some embodiments, the substrate can have at least two layers including a first top layer comprising the metallic particles and a second bottom layer comprising the aerogel particles. In some embodiments, the substrate can further comprise at least a third layer comprising a phase change material for absorbing conducted thermal energy. In some embodiments, the first layer can further comprise a phase change material for absorbing conducted thermal energy. The aerogel particles can be selected from a group consisting of softwood kraft lignin, nanocellulose, algae, moss, silica, alumina, titania, zirconia, cadmium sulfide, and iron oxide. The aerogel particle layer can have a density from 0.0001 to 900 g/cm³ and an average pore size from 1 to 100,000 nm. The phase change material can be polyethylene glycol or encapsulated paraffin. The metallic particles are selected from a group consisting of: Ag, Cu, antimony tin oxide, magnesium oxide, silicon dioxide, zirconium dioxide, indium tin oxide, atimony trioxide, zinc oxide, and antimony zinc. The metallic particles can have a density from 0.1% wt. to 90% wt. and an average particle size from 1 nm to 200 μm.

The first layer can comprise non-woven electrospun nanofibers or wet-spun fibers embedded with the metallic particles. The first layer can have a polymer matrix composed of a biodegradable polymer or co-polymer, wherein the polymer matrix has a composition comprising polyethylene glycol-based polyurethane. The first layer can further comprise at least one colouring dye.

The thermally insulating substrate product can further comprise a top fabric layer attached to a top surface of the substrate, and a bottom fabric layer attached to a bottom surface of the substrate. Alternatively, the product can the comprise a fabric layer in between the first and second layers.

The substrate can comprise fluid flow channels configured to pass fluid such as a gas through the substrate.

The substrate can have a textile layer formed from threads embedded with the metal particles. Further, the substrate can have a textile layer woven from a first set of threads embedded with the metallic particles and a second set of threads embedded with a phase change material. Alternatively, the substrate can have a textile layer woven from a first set of threads embedded with the metallic particles and a second set of threads embedded with the aerogel particles. Alternatively, the substrate can have a textile layer woven from a combination of a first set of threads embedded with metallic particles, a second set of threads embedded with the aerogel particles, and a third set embedded with a phase change material.

The first layer of the substrate can be a first textile layer woven from threads embedded with the metallic particles, and the third layer of the substrate can be a textile layer woven from threads embedded with the phase change material. The first and second set of threads can be functional weft and warp yarns interwoven together orthogonally. The first and second set of threads can have a woven structure selected from a group consisting of: single jersey, in-lay, rib, interlock, and plaited.

### BRIEF DESCRIPTION OF THE DRAWINGS

FIGS. 1(a)-(d) are schematic sectional side views of a thermally insulating substrate product according to embodiments of the invention, wherein FIG. 1(a) shows a thermally insulating substrate product having a surface layer with no pattern, FIG. 1(b) shows a thermally insulating substrate having a patterned surface layer, FIG. 1(c) shows a thermally insulating substrate attached to an exterior fabric layer having a pattern, and FIG. 1(d) shows a thermally insulating substrate having an integrated fabric layer.

FIGS. 2(a)-(e) are infrared images of a square sample of the thermally insulating substrate product in various applications, wherein FIG. 2(a) shows the square sample held in a hand and located indoors, FIG. 2(b) shows the square sample attached to a military uniform overlaid on an optical image and located indoors, FIG. 2(c) shows the square sample attached to a military uniform and located indoors, FIG. 2(d) shows the square sample attached to a military uniform and located outdoors, and FIG. 2(e) shows the square sample attached to a painted hot metal plate and located indoors.

FIG. 3 is a schematic sectional side view of an insulating cushion comprising the thermally insulating substrate product, according to another embodiment.

FIG. 4 is a schematic sectional side view of thermally insulating materials of the thermally insulating substrate product, including IR blocking particles, aerogel material and phase change material having fiber, foam or particulate structure with controlled breathability.

FIGS. 5(a) to (i) are schematic views and a microscope image of textile embodiments of the thermally insulating substrate product, comprising woven yarn threads in different configurations, wherein FIG. 5(a) shows a single hollow yarn thread, FIG. 5(b) is a microscope image of the yarn thread of FIG. 5(b), FIG. 5(c) shows a woven layer of two yarn threads having different thermally insulating properties, FIG. 5(d) shows the textile having two woven layers encapsulating an aerogel-containing layer, wherein the two woven layers comprises a top IR blocking layer and a bottom phase change layer, and FIGS. 5(e)-(l) show different weave or knit configurations of the yarn threads.

FIGS. 6(a)-(i) are schematic diagrams showing the thermally insulating substrate product used in different applications, wherein FIG. 6(a) shows the thermally insulating substrate product used in a helmet, FIG. 6(b) shows the thermally insulating substrate product used in a tent, FIG. 6(c) shows the thermally insulating substrate product used in base layer clothing, FIG. 6(d) shows the thermally insulating substrate product used in a glove, FIG. 6(e) shows the thermally insulating substrate product used on a vehicle structure, FIG. 6(f) shows the thermally insulating substrate product used in a seat structure, FIG. 6(g) shows the thermally insulating substrate product used in a sleeping bag, FIG. 6(h) shows the thermally insulating substrate product used in a jacket, and FIG. 6(i) shows the thermally insulating substrate product used in a sock.

### DETAILED DESCRIPTION OF EMBODIMENTS OF THE INVENTION

Embodiments described herein relate to a thermally insulating substrate product and a method for manufacturing same, suitable for applications to reduce heat loss or exposure to external heat or radiation, regulate body temperature, and/or provide thermal camouflage.

The term “substrate” in this description means a base material on or in which processing is conducted, and includes textiles and films. The term “thermally insulating” in this description means selectively containing or controlling the passage of thermal energy by one or more of IR radiation, thermal convection and thermal conduction.

Embodiments of the thermally insulating substrate product comprise a base material containing metallic (i.e. metal or metal oxide) particles having an average particle size and density selected to reflect and block IR radiation, and a nanoporous aerogel material that have a selected porosity and density to control or block thermally-convected and thermally-conducted energy. “Nanoporous” in this description means a material with either open or closed pores with at least one dimension in nanometer range, and typically between one and a few hundred nm, for example between 1-200 nm. In some embodiments, the thermally insulating substrate product also comprises a phase change material to absorb thermal energy.

In some embodiments, the thermally insulating substrate product is a coating wherein the substrate is a film. The term “film” as used in this description means a thin layer having a non-woven structure. The film substrate can be composed of non-woven electrospun nanofibers or wet-spun fibers. In some other embodiments, the thermally insulating substrate product is a textile wherein the substrate comprises woven threads. The term “textile” as used in this description means a flexible material made by creating an interlocking bundle of yarns or threads. The thermally insulating textile can be produced as a flexible, light and thin fabric for use in external environmental conditions for thermal camouflage as well for thermal insulation, energy conservation and/or thermal regulation. In some embodiments, the thermally insulating textile can be added to an existing fabric without adversely impacting the use and function of the existing fabric. In some other embodiments, the thermally insulating textile can comprise one or more foam layers, to provide thermal insulation as well as a spongy cushion and mechanical support for various clothing products such as puffy jackets and shoes, and for other applications such as vehicles and buildings. The substrate of the thermally insulating textile can be formed from yarns and threads of varying diameters and be integrated in a woven, knitted, braided or unwoven fabric structures.

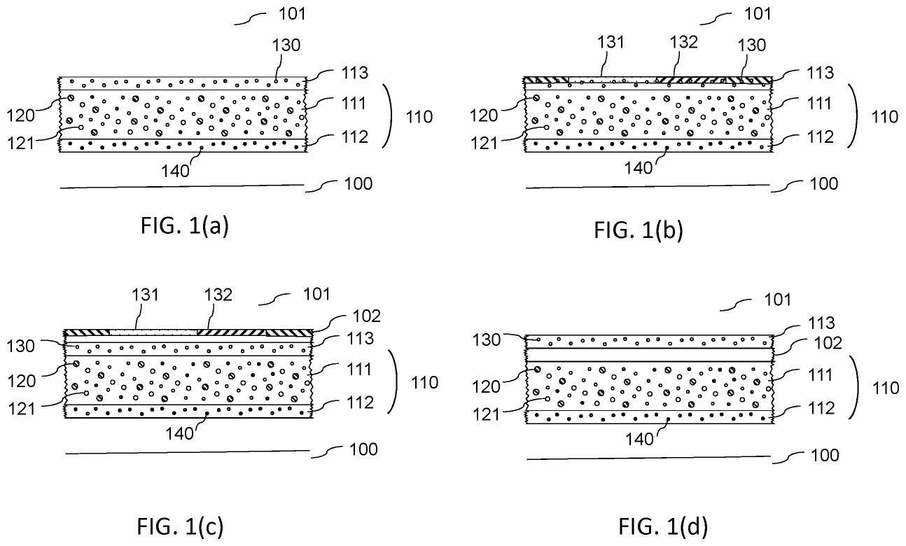

Referring now to FIG. 1(a) and according to a first embodiment, a thermally insulating substrate product 110 is shown covering a thermally emissive object 100 such as a human or a vehicle in an external environment 101. The external environment can be hot or cold, day or night, outside or inside, at high or low altitude, different weather conditions including but not limited to rainy, snowy, windy, stormy, in a city, a desert, an icy field, a terrain, or a forest. The thermally insulating substrate product 110 comprises multiple layers including a first layer 111 comprising a nanoporous material containing aerogel particles 120 and pores 121 (“aerogel layer”), a second layer 112 comprising a phase change material 140 (“phase change layer”) and a third layer 113 comprising IR blocking particles 130 (“IR blocking layer”). In some embodiments, the phase change layer 112 and IR blocking layer 113 can each comprise a textile base material. In another embodiment, the aerogel layer 111 and IR blocking layer 113 can each comprise a textile base material. The function of this embodiment is not only to block heat loss from body in a cold environment but also serves to block external IR radiation from heating up a body in a hot environment.

The aerogel layer 111 has a light foam or sponge-like structure that can provide exceptional heat insulation. A characteristic feature of aerogels which makes them suitable as efficient thermal insulations is their nanoporosity, wherein pore diameters within the aerogel structure in the nanometer range limit the mean free path of air molecules. Even at ambient air pressure the gaseous thermal conductivity within the aerogel is thus considerably lower than the conductivity of free air. The aerogel layer 111 provides a nanoporous structure that helps in creating low thermal conductance and air pockets for reduced thermal convection. The nanoporous aerogel layer 111 can provide thermally insulating properties while having a very light weight and thin profile. The aerogel material can provide other desired properties such as fire retardation and protection from heat. Some natural sources of the aerogel material are low cost, renewable, sustainable, have a low carbon footprint, and are disposable and recyclable.

The aerogel particles 120 of the aerogel layer 111 provide thermal insulation against conductive and convective heat transfers as well some scattering of IR emissions. Suitable examples of aerogel particles include: organic materials such as softwood kraft lignin, nanocellulose, algae and moss; natural materials such as silica, alumina, titania, zirconia, cadmium sulfide (CdS), and iron oxide; and carbon allotropes and polymers known in art used to form aerogel. The aerogel layer 111 can be a film made entirely of aerogel particles (not shown) or a foam matrix having embedded aerogel particles 120 and air gaps and bubbles 121 that can form closed pores of open pores. The foam matrix can be formed as an open pore porous structure (e.g. having interconnected bubbles) when it is desired to control thermal convection (rather than block thermal convection altogether); the pores can be nanoscale pores having a selected density and pore size to provide a desired convective heat transfer through the aerogel layer 111. A suitable density is in the range of 0.0001 to 900 g/cm³ and a suitable pores size is between 1 and 100,000 nanometers.

In an exemplary embodiment, the aerogel layer 111 is made from softwood kraft lignin by creating a gel which is then freeze-dried to form an aerogel material have highly porous with different pore sizes and structures. The aerogel material can then be made into powder or particles and incorporated in a foam matrix as shown in FIG. 1(a). In another exemplary embodiment, the aerogel particles 120 or films can be made from algae including but not limited to Irish moss, through steps of forming a gel and freeze-drying or any other aerogel formation methods.

The phase change layer 112 comprises a phase change material 140 having an extremely high latent heat due to the phase change process at a specific phase change transition temperature, particularly in the range of 100-200 J/g; as result, the phase change material is highly effective at absorbing and latent release of conducted thermal energy. Suitable example phase change materials include: natural materials such as polyethylene glycol (PEG), and encapsulated paraffin. The phase change material layer 112 can be coated onto the aerogel layer 111 by creating a solution of the phase change materials and spraying on the surface of the aerogel layer 111. The phase change material can coat the surfaces of the aerogel layer 111 and penetrate onto some of the sub-surfaces, producing an embedded nanocomposite structure. Other deposition methods such as soaking and vacuuming can be used for integration of the phase change material with the aerogel to form an integrated composite. The formation of layers 111 and 112 can be non-continuous and spotty or in form of fibers or textile to achieve breathability as well as insulation.

The IR blocking particles 130 of the IR blocking layer 113 provides thermal insulation by reflecting or scattering IR emissions. Suitable IR blocking particles 130 have the following optical properties: for metal particles, abundant free electrons and crystal structure leading to a high reflectivity for different parts of IR radiation spectrum; for metal oxide particles, a high band gap, typically in the range of 1.9 to 3.8, a high reflective index, typical value of 1.9, a disordered structure and/or having free electrons (n-type) that make surface plasmonic resonance. Suitable examples of IR blocking particles 130 include metallic (metal and metal oxide) particles that provide strong IR blocking and reflection due to high surface plasmon resonance (SPR) effect, such as Ag, Cu, Al, Au and metal oxides like magnesium oxide (MgO), silicon dioxide (SiO₂), zirconium dioxide (ZrO₂), antimony-tin-oxide (ATO), indium tin oxide (ITO), antimony trioxide (Sb₂O₃), zinc oxide (ZnO) and antimony-zinc (Sb—Zn) or alloys of such metallic particles for increasing IR reflection and durability. The metallic particles can be nanoparticles having an average size range of one to a few hundred nanometers, e.g. 1-1,000 nm or microparticles having an average size range of one to a few hundred micrometers, e.g.1-500 μm.

In some embodiments, the IR blocking layer 113 comprises a thin film nanostructured base layer including non-woven electrospun nanofibers or wet-spun or melt-spun or melt-blown fibers having a composite of polymer and metallic particles as the IR blocking particles 130. The IR-blocking metallic particles 130 can be embedded in a polymer matrix of nanofibers or wet-spun or melt-blown fibers to provide superior adhesion and binding and can be fabricated from a composite ink in one step. Suitable materials for the polymer matrix include polyurethane, polyethylene glycol or a combination thereof and thermoplastics such as polypropylene. The density of IR blocking metallic nanoparticles 130 can be selected to achieve a desired level of IR blocking as well as a desired visible color of the IR blocking layer 113. The concentration of IR blocking particles 130 can be in the range of 0.1% wt. to 90% wt. A mixture of different IR blocking particles 130 can be used to achieve desired IR blocking as well as the visible color of the film. The film can be continuous or spotty to achieve breathable construction or desired pattern for IR blocking or visible pattern.

In another embodiment, the polymer matrix of the IR blocking layer 113 can be a biodegradable polymer of co-polymer including but not limited to polyethylene glycol (PEG)-based polyurethane (PU), which improves thermal regulation and insulation due to phase change material properties of PEG and keeps the ATO layer bound, integrated and stable. In yet another embodiment, the IR blocking layer 113 can have an electro-spun polymer base layer containing metallic IR blocking particles 130 with a rough surface with topographic features in the range of nano or micrometer, which contributes to IR scattering and reflection. For example, the IR blocking layer has a rough surface due to fiber structures as well as polymer (PU) and ATO or metallic nanoparticles.

In another embodiment (not shown), the thermally insulating substrate product 110 can comprise a single layer comprising both phase change material and IR blocking particles 130.

Referring now to FIG. 1(b) and according to a second embodiment, the thermally insulating substrate product 110 has a IR blocking layer 113 comprising a mixture of IR blocking particles 130 and coloring dyes 131 and 132 having distinct visible colors (for example, dark green or brown, . . . ) to create a desired visual print on the top surface of the thermally insulating textile 110. This can be used for achieving both visual and IR camouflage in the same fabric.

Referring to FIG. 1(c) and according to a third embodiment, the thermally insulating substrate product 110 comprises a conventional protective fabric 102 covering the outside of the IR blocking layer 113, and can be used in a jacket for consumer or military uses or in a tent or vehicle covering. The protective fabric 102 can have a specific visual print, for example a camouflage print that is achieved by printing dyes in regions 131 and 132. The external environment can be hot or cold, day or night, outside or inside, at high or low altitude, different weather conditions including but not limited to rainy, snowy, windy, stormy, in a city, a desert, an icy field, a terrain, or a forest. The protective fabric 102 can be used in applications including but not limited to: nylon/cotton ripstop military uniform fabric with camouflage prints or internal or external jacket layers, base layers, gloves, sleeves, tights, shorts or socks or other clothing fabric and layers. In this embodiment, the thermally insulating textile 110 is coated on the back of the protective fabric 102 which helps in maintaining the visible external appearance, design and prints of the fabric including visible camouflage patterns and other design prints. This embodiment of the thermally insulating textile 110 is particularly intended for heat storage, thermal insulation and temperature regulation with the temperature of the surrounding environment, and shielding and concealing of heat and IR emission from body, thus providing an adaptive camouflage and insulation. The embodiment can also block exposure to external IR radiation and heating from sun or other heating sources thus keeping the body, house or other objects cool.

Referring to FIG. 1(d) and according to a fourth embodiment, the thermally insulating substrate product 110 comprises a conventional protective fabric 102 placed between the IR blocking layer 113 and the aerogel layer 111. In this case, the IR blocking layer 113 has a composition selected to have desired visual colors by controlling the density of IR blocking nanoparticles or embedding coloring dyes. The visual coloring pattern can be designed to include any design or desired visual and IR camouflage.

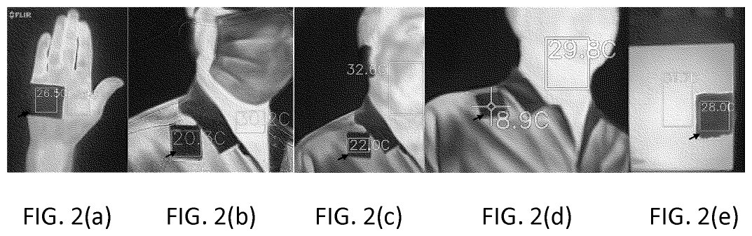

Referring to FIGS. 2(a)-(e), a square sample of the thermally insulating substrate product 110 was imaged using an IR camera against a number of surfaces, including a hand (FIG. 2(a)).

The resulting thermal image indicates that the thermally insulating substrate product 110 provides ˜9° C. drop to match and hide the emission of the hand (35.8° C.) located in an indoor environment at 26.5° C. As shown in FIG. 2(b), the square sample of the thermally insulating substrate product 110 was attached to a military uniform and reduced the thermal emission from the body (30.2° C.) located in an indoor environment at 20.3° C. In this image, the optical image overlay shows the visual camouflage pattern of a conventional military fabric. In FIG. 2(c), the square sample of the thermally insulating substrate product 110 was attached to a military uniform located in an indoor environment at 22° C. In FIG. 2(d), the square sample of the thermally insulating substrate product 110 was attached to a military uniform worn on a body (29.8° C.) and in an outdoor environment at 8° C.; this demonstrates a ˜21° C. temperature drop and generally matching the environment temperature. In FIG. 2(e), the square sample of the thermally insulating substrate product 110 is shown on a hot colored metallic plate (51.7° C.), reducing the measured temperature to 28° C. and matching to an external indoors environment.

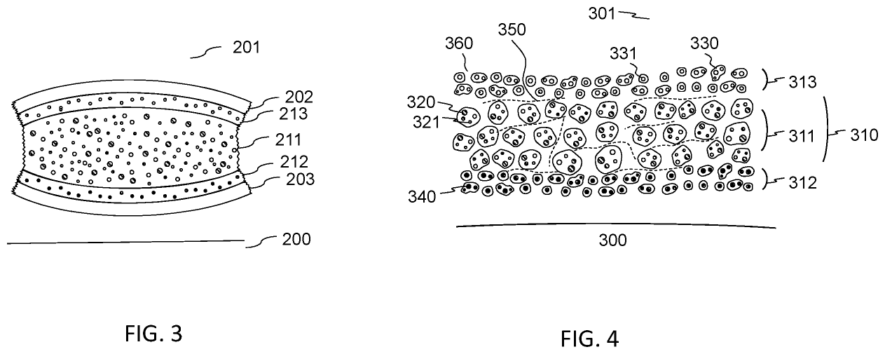

Referring now to FIG. 3 and according to a fifth embodiment, a thermally insulating substrate product 210 comprises multiple layers including an aerogel layer 211, a phase change layer 212, an IR blocking layer 213, a first conventional protective external fabric 202 covering the outside of the IR blocking layer 213 and a second conventional protective inner fabric 203 covering the outside of the phase change layer 212. This embodiment can be used as a jacket, a covering, a underlayer for consumer or military uniform or tent or accessories or shoes or vehicle covering, which covers an emissive body 200 that can be a human or a vehicle in an external environment 201. The external environment can be hot or cold, day or night, outside or inside, at high or low altitude, different weather conditions including but not limited to rainy, snowy, windy, stormy, in a city, a desert, an icy field, a terrain, or a forest. The protective external fabric 202 can used in applications including but not limited to: ripstop military uniform fabric with camouflage prints external jacket layers, shoe or boot external layer or covering, backpack covering, sleeping bag or mat covering, sleeves, tights, shorts or socks or other clothing fabric and layers. The protective internal fabric 203 can be the internal layer of a military uniform fabric, jacket layer, shoe or boot internal layer or covering, backpack covering, sleeping bag or mat covering, sleeves, tights, shorts or socks or other clothing fabric and layers. In another embodiment, the thermally insulating substrate product 210 can be used as internal insulation and IR blocking layer for any object or structure including but not limited to cars, shoes, houses rooms, doors or accessories.

In this embodiment, the aerogel layer 211, phase change layer 212, and IR blocking layer 213 are placed and encapsulated between the external 202 and internal 203 fabric layers and serve to provide conductive and convective thermal insulation and blocking of IR radiation for the purpose of heat preservation or IR concealing. These layers can be sewn together. In addition, the thermally insulating textile 210 has a highly porous structure, which provides a lightweight, “fluffy or puffy” structure that is highly compressible. More particularly, the aerogel layer 211 is configured to have a higher porosity and thickness than other embodiments to provide the desired structure. Additionally or alternatively, the aerogel layer 211 can be embedded with elastic and springy yarns to provide the desired structure. The thermally insulating textile 210 is particularly intended for heat storage, insulation and regulation with the temperature of surrounding environment, and shielding and concealing of heat and IR emission from body, thus providing an adaptive camouflage and insulation, mechanical cushioning, and a soft and compressible feel.

The IR blocking layer 213 can have the same or similar composition and structure as the IR blocking layer 113 of the first to fourth embodiments. The aerogel layer 211 can have the same or similar composition and structure as the aerogel layer 111 of the first to fourth embodiments. The IR blocking layer 213 can have the same or similar composition and structure as the IR blocking layer 113 of the first to fourth embodiments.

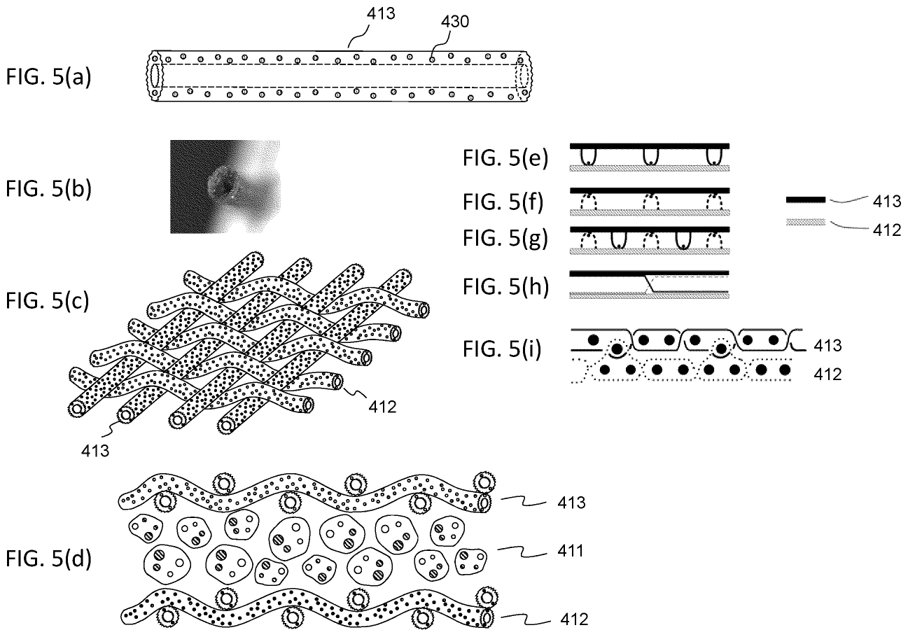

Referring to FIG. 4 and according to a sixth embodiment, a thermally insulating substrate product 310 comprises multiple film layers including a nanoporous aerogel containing layer 311, a phase change layer 312 and an IR blocking layer 313. The thermally insulating substrate product 310 covers an emissive body 300 that can be a human or a vehicle or an object located in an external environment 301. The external environment can be hot or cold, day or night, outside or inside, at high or low altitude, different weather conditions including but not limited to rainy, snowy, windy, stormy, in a city, a desert, an icy field, a terrain, or a forest.

In comparison to the embodiment shown in FIG. 1(a), each of the film layers 311, 312, and 313 are comprised of micro-structured and nano-structured particles, nanofibers, microfiber of the desired materials that form a porous packed layer with channels 360 that allows fluid flow (e.g. air, humidity and sweat) to pass through. These film layers 311, 312, 313 can be deposited from inks containing the desired particles of each layer using a 3D printer or roll-to-roll printer, screen printing or lamination processes. These film layers 311, 312, 313 can be electrospun and be in form of non-woven nanofibers whose approximate cross-section are displayed in FIG. 4. The IR blocking layer 313 can be configured to block all IR emission despite being highly porous structure by layering the IR blocking particles 330. Binding fibers or mesh 350 are used in the different layers 311, 312, 313 to hold the particles or nanofibers securely together while maintaining a high porosity. The IR blocking particles 330 and coloring dye particles 331 are used in IR blocking layer 313 to provide IR blocking as well as visible print or camouflage. The aerogel layer 311 is made from particles that contain aerogel particles 320 and air gaps and bubbles 321 like in the other embodiments but additionally with channels 360 that allow fluid flow. The phase change layer 312 comprises a phase change material 340 like in the other embodiments but additionally with channels 360 that allow fluid flow.

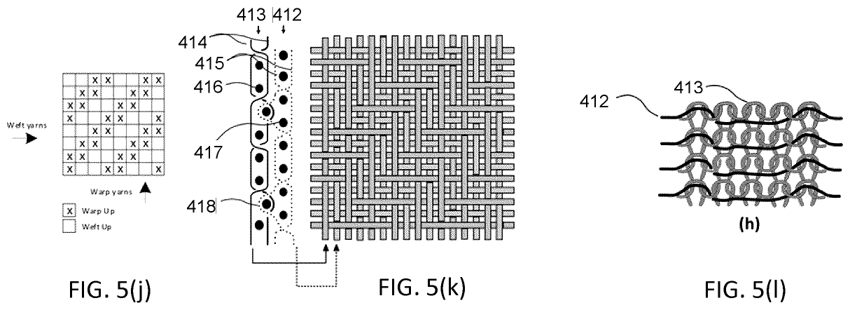

Referring now to FIGS. 5(a)-(i) and according to a seventh embodiment, the thermally insulating substrate product 410 comprises one or more textile layers containing thermally insulating materials. The different textile layers are each formed by spinning the material in form of a solid or hollow yarn whose shell contains the desired nanoparticles. For instance, as shown in FIG. 5(a), a IR blocking layer 413 can be spun from a thin hollow fiber whose shell contain the desired IR blocking nanoparticles 430 such as ATO, Cu, Ag or other IR blocking materials (“IR blocking yarn”). This can be done by wet-spinning, electrospinning or other fiber spinning methods that are used for fabrication of fibers from a source material. The electrospun materials can be in the form of web, having a microstructure made of entangled nanofibers. FIG. 5(b) shows an optical microscope image of a hollow Cu-PET fibers wet-spun with a diameter of 100 micrometers. Similarly, a phase change layer 412 can be spun from a fiber incorporating a phase change material (“phase change yarn”). Similarly, an aerogel layer can be spun from a fiber incorporating aerogel particles (“aerogel yarn”, not shown). FIG. 5(c) illustrates an embodiment comprising a thermally insulating substrate product 410 comprising a single textile base layer comprising interwoven phase change yarn 412 and IR blocking yarn 413 or aerogel yarn. The thermally insulating substrate product 410 provides both thermal convection and conduction insulation and regulation and IR insulation and concealing due to the presence of both IR blocking and phase change yarns 412, 413 in a woven structure. FIG. 5(d) demonstrates another embodiment of the thermally insulating substrate product 410, comprising two textile layers 412, 413 encapsulating an aerogel layer 411. The phase change layer 412 comprises a woven fabric of phase change yarns and the IR blocking layer 413 comprises a woven fabric of IR blocking yarns. The aerogel layer 411 comprises a highly particulate or fiber structure of aerogel foam.

Referring to FIG. 5(e) to 5(k), the textile layers 412, 413 can have functional weft and warp yarns interwoven together orthogonally. The woven structures can be in the form of double cloth or triple cloths with different variations of the principal structural types. The double cloths include self-stitched double cloths, center-stitched double cloths, thread-interchange double cloths (FIG. 5(h)), and cloth-interchange double cloths. The double cloths can contain two series of threads/yarns in both warp and weft directions to interweave orthogonally to form separate face and back fabric layers. The separate face and back layers can be the IR blocking yarn 413 and the phase change yarn 412 or aerogel yarn. Interconnection/stitching of each two separate layers can be accomplished by occasionally dropping a face warp under a back weft 417 (FIG. 5(e)) or lifting a back warp above the face weft 416 (FIG. 5(f)) or by utilizing both methods simultaneously (FIG. 5(g)) in the cloth with variable proportions. FIG. 5(e) and 5(g) shows the textile woven structures formed by lifting the back layer (412) warp 415 above 418 the face layer (413) weft 416. This is based on the design but not limited to 2/2 (two up and two down) twill weave with variable step or move numbers (FIG. 5(j)). The fabric structure can be a knitted fabric having phase change yarns 412 and IR blocking yarns 413 at different stitch densities for achieving desired insulation and IR blocking properties. A knitted fabric system may be but not limited to the structures including single jersey, in-lay (FIG. 5(k)), rib, interlock, and plaited structure. An embodiment depicted in the FIG. 5(h) can include knitted fabric but not limited to the functional low surface emissivity yarns and IR blocking yarns. Low surface emissivity yarns can be but not limited to nylon, polyester or any other synthetic filaments with or without texturing. These yarns may include dopants including but not limited to copper, silver, or any other low emissive particles. The IR blocking yarns may include but not limited to ATO, Cu, Ag, Al, Au reinforced with polymeric materials. All the aforementioned functional yarn systems (412, 413 or aerogel yarns) may be fabricated by but not limited to wet spinning, dry spinning, melt spinning, or any other fibre forming methods. The cross-section of these filaments can include but not limited to hollow, solid or any other type of geometry. The hollow filament systems may include any type of phase change materials but not limited only to this. The fabric structure can be complex three-dimensional braiding and jacquard braiding to achieve desired fabric structure, form and desired heat and IR insulation for a variety of applications including clothing, military accessories, structural components, biomedical applications, implanted components.

The phase change yarns 412 and IR blocking yarns 413 can be incorporated in the compositions of the conventional protective external and internal fabrics such as 102 and 202 and 203 as described above. The integration technique could include fabric production methods such as weaving, knitting, braiding or embroidery.

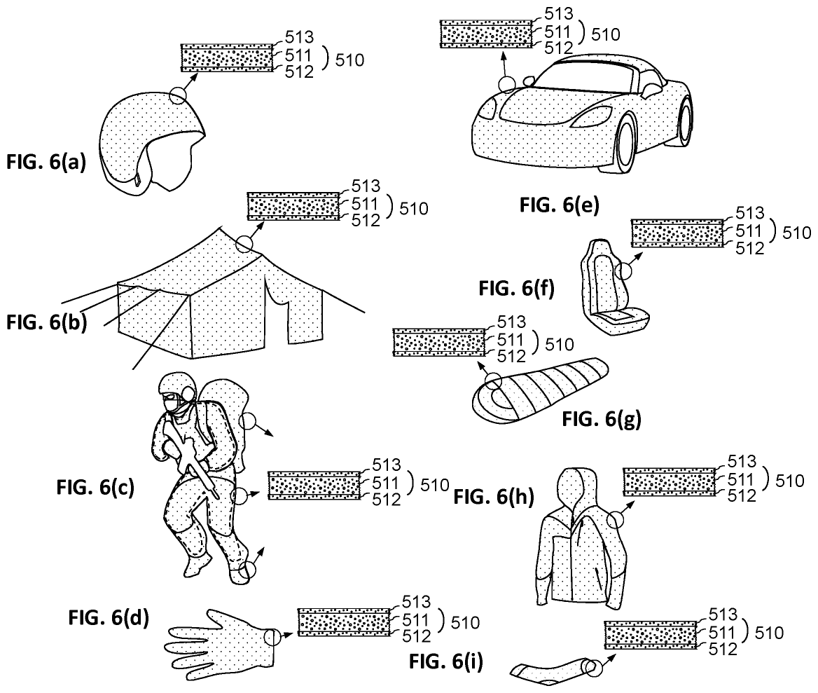

In another embodiment as shown in FIGS. 6(a)-(i), the thermally insulating substrate product 510 comprises the aerogel layer 511, the phase change layer 512 and IR blocking layer 513, and can be coated on the surface of or attached to objects having various surface finishes including but not limited to: metal, wood, and concrete. The aerogel layer 511 has a controllable porosity and thickness to provide the desired thickness, for this embodiment of the invention. The aerogel layer 511 can be embedded with elastic and springy yarns or embedded composition to provide springy mechanical feel and support for weight. The aerogel layer 511 can be embedded with a phase change layer 512 to add extreme thermal capacity to absorb heat and regulate temperature by virtue of its latent heat of the material used. The IR blocking layer 513 comprises IR blocking particles with very low IR emissivity, strong IR reflection and scattering.

The object 500 as shown in FIG. 6(a) can be a helmet, a military helmet, a hat or any other protective head gear, having a visible camouflage, or another pattern, print or no pattern, which is in an external environment 501. The object 500 as shown in FIG. 6(b) can be a tent, a house (embedded insulation in the walls or subsurfaces), a room, a roof, an awning, a window screen, curtain or shutter, an umbrella or any other temporary or permanent structure or covering, having a visible camouflage, or another pattern, print or no pattern, which is in an external environment 501. The object 500 as shown in FIG. 6(c) can be a uniform including pants, a shirt, a jacket, an undershirt, underpants, shoes, boots, sandals, space suite, having a visible camouflage, or another pattern, print or no pattern, which is in an external environment 501. The object 500 as shown in FIG. 6(d) can be gloves, protective gloves, gaming gloves, surgical gloves, rehabilitation gloves, work gloves, ski gloves, having a visible camouflage, or another pattern, print or no pattern, which is in an external environment 501. The object 500 as shown in FIG. 6(e) can be a vehicle, a truck, a motorcycle, a tank, a bus, a helicopter, an airplane, an unmanned aerial vehicle (UAV), a drone, an unmanned ground vehicle (UGV), an electric vehicle, an electric truck, an electric bus, a ship, a boat, space shuttle, satellite or any other ground, air, sea and space vehicles, having a visible insulation and camouflage suited for their environment, or another pattern, print or no pattern, which is in an external environment 501. The object 500 as shown in FIG. 6(f) can be a chair, a seat, a child seat, a camping chair, a lounge chair, an inflatable chair or any other seating or lounging chair, having a visible camouflage, or another pattern, print or no pattern, which is in an external environment 501. The object 500 as shown in FIG. 6(g) can be a sleeping bag, a compactable sleeping bag, an insulation mat, a rug, a spacer, having a visible camouflage, or another pattern, print or no pattern, which is in an external environment 501. The object 500 as shown in FIG. 6(h) can be a jacket, a jacket with hat, a fluffy jacket, a compactable jacket, a pillow, a blanket, a mattress, having a visible camouflage, or another pattern, print or no pattern, which is in an external environment 501. The object 500 as shown in FIG. 6(i) can be socks, stockings, compression stockings, compression socks, sleeves, shoe insoles, having a visible camouflage, or another pattern, print or no pattern, which is in an external environment 501.

The thermally insulating substrate product 510 is specifically designed for heat storage, insulation and regulation with the temperature of surrounding environment, and shielding and concealing of heat and IR emission from body, thus providing an adaptive camouflage and insulation, and mechanical cushion, soft and compressible feel for the fabric. The thermally insulating substrate product 510 is intended to provide superior thermal conductive and convective insulation, and IR radiation blocking for the purpose of heat preservation or IR concealing. The external environment can be hot or cold, day or night, outside or inside, at high or low altitude, different weather conditions including but not limited to rainy, snowy, windy, stormy, in a city, a desert, an icy field, a terrain, or a forest.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“linked”, “connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a substrate, assembly, device, manifold, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments described herein.

Specific examples of systems, methods, and apparatus have been described herein for purposes of illustration. These are only examples. The technology provided herein can be applied to systems other than the example systems described above. Many alterations, modifications, additions, omissions, and permutations are possible within the practice of this disclosure. This disclosure includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While particular elements, embodiments and applications of the present disclosure have been shown and described, it will be understood, that the disclosure is not limited thereto since modifications can be made by those skilled in the art without departing from the scope of the present disclosure, particularly in light of the foregoing teachings. It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A thermally insulating substrate product comprising:
a substrate having at least one layer and comprising metallic particles having an average particle size and density selected to block or reflect infrared radiation and aerogel particles having an average pore size selected to control conducted and convected thermal energy; and
wherein the substrate has a textile layer woven from a first set of threads embedded with the metallic particles and a second set of threads embedded with a phase change material or with the aerogel particles.

2. The thermally insulating substrate product as claimed in claim 1 wherein the substrate has at least two layers including a first top layer comprising the metallic particles and a second bottom layer comprising the aerogel particles.

3. The thermally insulating substrate product as claimed in claim 2, wherein the substrate further comprises at least a third layer comprising a phase change material for absorbing conducted thermal energy.

4. The thermally insulating substrate product as claimed in claim 2 wherein the first top layer further comprises a phase change material for absorbing conducted thermal energy.

5. The thermally insulating substrate product as claimed in claim 1, wherein the aerogel particles are selected from a group consisting of: softwood kraft lignin, nanocellulose, algae, moss, silica, alumina, titania, zirconia, cadmium sulfide, and iron oxide.

6. The thermally insulating substrate product as claimed in claim 1, wherein the metallic particles are selected from a group consisting of: Ag, Cu, Al, Au, antimony tin oxide, magnesium oxide, silicon dioxide, zirconium dioxide, indium tin oxide, atimony trioxide, zinc oxide, and antimony zinc.

7. The thermally insulating substrate product as claimed in claim 1, wherein the phase change material is polyethylene glycol or encapsulated paraffin.

8. The thermally insulating substrate product as claimed in claim 2 wherein the first top layer comprises non-woven electrospun nanofibers or wet-spun fibers embedded with the metallic particles, or wherein the first top layer is a polymer matrix composed of a biodegradable polymer or co-polymer.

9. (canceled)

10. The thermally insulating substrate product as claimed in claim 8 wherein the polymer matrix has a composition comprising polyethylene glycol-based polyurethane.

11. The thermally insulating substrate product as claimed in claim 1 wherein the metallic particles have a density from 0.1% wt. to 90% wt. and an average particle size from 1 nm to 200 μm.

12. The thermally insulating substrate product as claimed in claim 1 wherein the aerogel particles have a density from 0.0001 to 900 g/cm³ and an average pore size from 1 to 100,000 nm.

13. The thermally insulating substrate product as claimed in claim 2 wherein the first top layer further comprises at least one colouring dye.

14. The thermally insulating substrate product as claimed in claim 1 further comprising a top fabric layer attached to a top surface of the substrate, and a bottom fabric layer attached to a bottom surface of the substrate.

15. The thermally insulating substrate product as claimed in claim 2 wherein the substrate comprises a fabric layer in between the first top and second bottom layers.

16. (canceled)

17. The thermally insulating substrate product as claimed in claim 1 wherein the substrate comprises fluid flow channels configured to pass fluid through the substrate.

18. The thermally insulating substrate product as claimed in claim 1 wherein the substrate has a textile layer formed from threads embedded with the metal particles.

19. The thermally insulating substrate product as claimed in claim 3 wherein the first top layer of the substrate is a first textile layer woven from threads embedded with the metallic particles, and the third layer of the substrate is a textile layer woven from threads embedded with the phase change material.

20. The thermally insulating substrate product as claimed in claim 19 wherein the first and second set of threads are functional weft and warp yarns interwoven together orthogonally, or have a woven structure selected from a group consisting of: single jersey, in-lay, rib, interlock, and plaited.

21. (canceled)

22. A thermally insulating and breathable textile product comprising:
at least one textile layer comprising a first set of yarns comprising metallic particles having a density and average particle size selected to block or reflect infrared radiation, and a second set of yarns comprising aerogel particles having a density and average pore size selected to control conducted and convected thermal energy; and
wherein the at least one textile layer has a porous weave to pass fluid including air and water vapour.

23. The textile product as claimed in claim 22 wherein at least some of the yarns are hollow yarns.

24. The textile product as claimed in claim 22 further comprising a third set of yarns comprising a phase change material for absorbing conducted thermal energy.

25. The textile product as claimed in claim 22, wherein the density and average particle size of the metallic particles are selected such that an IR emission through the at least one textile layer is in a range of IR emissions of an external environment, thereby providing IR camouflage.

26. The textile product as claimed in claim 22, wherein the density and average pore size of the aerogel particles are selected such that the temperature of an outer surface of the at least one textile layer is in a range of temperature of an external environment, thereby providing thermal camouflage.

27. The textile product as claimed in claim 22, wherein at least some of the yarns comprise a colouring dye, thereby providing optical camouflage.

28. A thermally insulating, breathable and camouflaging substrate product, comprising:
(a) a first top layer comprising metallic particles having a selected density and particle size to block or reflect IR radiation thereby providing thermal insulation and IR camouflage;
(b) a second central layer comprising aerogel particles having a selected density and pore size to control conducted and convected thermal energy thereby providing thermal insulation and thermal camouflage; and
(c) a third bottom layer comprising a phase change material for absorbing conducted thermal energy thereby providing thermal insulation and thermal camouflage; wherein the three layers have a selected porosity to pass fluid including air and water vapour, thereby providing breathability.

29. (canceled)

30. (canceled)

19. The thermally insulating substrate product as claimed in claim 1 wherein the substrate has a textile layer woven from a first set of threads embedded with the metallic particles and a second set of threads embedded with a phase change material.

20. The thermally insulating substrate product as claimed in claim 1 wherein the substrate has a textile layer woven from a first set of threads embedded with the metallic particles and a second set of threads embedded with the aerogel particles.

21. The thermally insulating substrate product as claimed in claim 3 wherein the first top layer of the substrate is a first textile layer woven from threads embedded with the metallic particles, and the third layer of the substrate is a textile layer woven from threads embedded with the phase change material.

22. The thermally insulating substrate product as claimed in claim 21 wherein the first and second set of threads are functional weft and warp yarns interwoven together orthogonally.

23. The thermally insulating substrate product as claimed in claim 22 wherein the first and second set of threads have a woven structure selected from a group consisting of: single jersey, in-lay, rib, interlock, and plaited.

24. A thermally insulating and breathable textile product comprising:
at least one textile layer comprising a first set of yarns comprising metallic particles having a density and average particle size selected to block or reflect infrared radiation, and a second set of yarns comprising aerogel particles having a density and average pore size selected to control conducted and convected thermal energy; and
wherein the at least one textile layer has a porous weave to pass fluid including air and water vapour.

25. The textile product as claimed in claim 24 wherein at least some of the yarns are hollow yarns.

26. The textile product as claimed in claims 24 or 25 further comprising a third set of yarns comprising a phase change material for absorbing conducted thermal energy.

27. The textile product as claimed in any one of claims 24 to 26, wherein the density and average particle size of the metallic particles are selected such that the IR emission through the at least one textile layer is in the range of IR emissions of an external environment, thereby providing IR camouflage.

28. The textile product as claimed in any one of claims 24 to 27, wherein the density and average pore size of the aerogel particles are selected such that the temperature of an outer surface of the at least one textile layer is in the range of temperature of an external environment, thereby providing thermal camouflage.

29. The textile product as claimed in any one of claims 24 to 29, wherein at least some of the yarns comprise a colouring dye, thereby providing optical camouflage.

30. A thermally insulating, breathable and camouflaging substrate product, comprising:
(a) a first top layer comprising metallic particles having a selected density and particle size to block or reflect IR radiation thereby providing thermal insulation and IR camouflage;
(b) a second central layer comprising aerogel particles having a selected density and pore size to control conducted and convected thermal energy thereby providing thermal insulation and thermal camouflage; and
(c) a third bottom layer comprising a phase change material for absorbing conducted thermal energy thereby providing thermal insulation and thermal camouflage;
wherein the three layers have a selected porosity to pass fluid including air and water vapour, thereby providing breathability.
